(19) United States
(12) Patent Application Publication
(10) Pub. No.: US 2009/0000263 A1
(43) Pub. Date: Jan. 1, 2009

(54) Harvesting and Threshing System

(76) Inventor: John Gossop, East Riding (GB)

Correspondence Address: VENABLE LLP, P.O. BOX 34385, WASHINGTON, DC, 20043-9998, US

(21) Appl. No.: 11/885,596

(22) PCT Filed: Feb. 22, 2006
(86) PCT No.: PCT/GB06/00610

§ 371 Date: Aug. 5, 2008

(30) Foreign Application Priority Data
Mar. 2, 2005 (GB) 0504266.8

(51) Int. Cl. A01D 39/00

(52) U.S. Cl. 56/432

(57) ABSTRACT

A harvesting device for harvesting agricultural crops being adapted to harvest an agricultural crops, to compress the agricultural crop into bales, and to strip loose material from at least a portion of the surface region of a bale of the agricultural crop.

The present invention relates to a system of harvesting and threshing agricultural crops such as cereals, pulses and oilseeds.

Harvesting and threshing machines are already known in the art. Such machines are generally used in a field where the crop to be harvested and threshed is grown. A combined harvester incorporates a harvesting device and a threshing device in a single machine. First, the combined harvester cuts and picks up the crop and then separates the good grain from the weed seeds, chaff and straw (threshing), retaining the good grain in a container in the harvester's body and discarding the weed seeds, chaff and straw to the ground. This process leaves a swath of straw in the field which is subsequently baled using a separate baling machine. This requires a farmer to cover each field twice (with a tractor) using up valuable time and fuel.

This way of harvesting and threshing the crop also fails to collect the weed seeds, chaff and light or broken grains from the crop. These uncollected seeds and grain are left in the field causing weed infestation and wasting valuable animal feed.

It is one of the objects of the preset invention to address the above mentioned problems and provide a system of harvesting and threshing agricultural crops which takes less time and fuel and also reduces the loss of weed seeds, chaff and grain from the harvested crop.

According to a first aspect of the present invention there is provided a harvesting device for harvesting agricultural crops comprising:
harvesting means adapted to harvest an agricultural crop;
baling means adapted to compress the agricultural crop into bales; and
bale stripping means adapted to strip loose material from at least a portion of the surface region of a bale of agricultural crop.

According to a second aspect of the present invention there is provided a baling machine adapted to gather and compress an agricultural crop into discreet packages, the baling machine comprising a bale stripping device comprising bale stripping means adapted to strip loose material from at least a portion of a surface region of a bale of agricultural crop as.

According to a third aspect of the present invention there is provided a bale stripping device comprising bale stripping means adapted to strip loose material from at least a portion of a surface region of a bale of agricultural crop.

Preferably, the bale stripping means comprises at least one bale stripping member.

Preferably, the at least one bale stripping member comprises brushing means which brushing means are preferably adapted to brush at least a portion of the surface region of a bale of agricultural crop.

Preferably, the bale stripping means comprises a plurality of bale stripping members.

Preferably, the bale stripping means comprises bale stripping members situated to correspond with each face of a bale to be stripped.

Preferably, at least one of the at least one bale stripping member is substantially cylindrical.

Preferably, the or each bale stripping member is substantially cylindrical.

Preferably, at least one of the or each bale stripping member is adapted to rotate.

Preferably, the or each of the bale stripping members is adapted to rotate.

Preferably, at least one of the or each bale stripping members is substantially cylindrical and adapted to rotate about its longitudinal axis.

Preferably, the or each bale stripping member is substantially cylindrical and each independently adapted to rotate about its longitudinal axis.

Preferably, the bale stripping device is incorporated into a baling machine.

By baling machine it is meant a machine that gathers agricultural crop and compresses it into discrete packages known as bales.

By bale it is meant a discrete package of a compressed substance, usually held together by twine (known as baling twine) but which may be held together by any other suitable means.

By agricultural crop it is meant any crop cultivated on arable land. Examples of agricultural crops include but are not restricted to wheat, corn, barley, oats, oilseed rape, beans, peas, linseed and the like.

Preferably, the bale stripping means is incorporated into a harvesting and baling machine.

Preferably, the harvesting means comprises at least one cutting portion operable to cut the agricultural crop.

Preferably, the at least one cutting portion comprises a blade which preferably extends across the width of the harvesting device. Preferably, the harvesting means comprises a number of blade members which are preferably triangular in shape.

Preferably, the harvesting means comprises a plurality of cutting portions operable to cut the agricultural crop.

Preferably, the harvesting means comprises a gathering member. Preferably, the gathering member is adapted to rotate about an axis substantially parallel to a plane of the land upon which the agricultural crop to be harvested is growing.

Preferably, the gathering member is adapted to rotate in a direction such that it pulls the arable crop and feeds it into the harvesting device.

Advantageously, such a harvesting device is operable to harvest and bale the crop without threshing, thereby minimising the risk of losing any grain or seeds.

Preferably, the baling means comprises a baling chamber and preferably compression means adapted to compress the harvested agricultural crop within the baling chamber.

Preferably, the harvesting device comprises crop delivery means adapted to deliver the harvested crop to the baling chamber.

Preferably, the harvesting device comprises chopping means adapted to chop the harvested crop into smaller parts.

Preferably, the chopping means is adapted to chop the harvested crop into smaller parts while the harvested crop is situated on the crop delivery means. Alternatively, the chopping means may be adapted to chop the harvested crop into smaller parts while the harvested crop is situated on a shelf between the harvesting means and the crop delivery means.

Preferably, the chopping means comprises a substantially cylindrical roller having at least one and preferably a plurality of blades projecting, preferably radially therefrom.

Preferably, the substantially cylindrical roller is adapted to rotate about its longitudinal axis.

Preferably, the crop delivery means comprises a conveyor which is preferably adapted to be moveable with respect to the harvesting device.

Preferably, the crop delivery means is adapted to deliver the harvested crop between the harvesting means and the baling means.

Preferably, the crop delivery means is angled upward from the harvesting means to the baling means, preferably at an angle between 20° and 60° to the horizontal. More preferably, between 30° ad 50° and most preferably about 40° to the horizontal (when in use).

Preferably, the delivery means comprises a conveyor or the like.

Preferably, the harvesting device further comprises loose material receiving means which loose material receiving means are preferably adapted to receive loose material which is stripped from at least a portion of a surface region of a bale of agricultural crop.

Preferably, the bale stripping means are adapted to strip loose material from at least a portion of the surface region of the bale of arable crop while said bale of arable crop is located in the baling chamber.

Preferably, the harvesting device is adapted to be towed by a tractor. Preferably, the harvesting means, baling means and bale stripping means are adapted to be powered by a tractor, preferably via a power take off shaft fitted to a tractor.

In an alternative embodiment, the harvesting device may comprise driving means operable to drive the harvesting means, baling and/or bale stripping means. The harvesting device may comprise means to enable it to move relative to the ground. For example, the harvesting device may be incorporated into a vehicle.

Preferably, the harvesting device comprises bale delivery means adapted to deliver the bale from the baling chamber. The bale may be delivered to an accompanying unit such as a trailer or, alternatively may be delivered to the ground outside the harvesting device.

The bale delivery means may comprise a conveyor belt or the like or may comprise a chute which the bale may slide along.

Preferably, the harvesting device comprises loose material returning means adapted to return loose material which has been stripped from at least a portion of the surface region of the bale of agricultural crop to the baling means.

Advantageously and preferably, loose material stripped from at least a portion of the surface region of the bale may then be returned to the baling means to be re-baled. In this manner, loose material is advantageously concentrated toward the centre of the bale thereby reducing the risk of losing grain by movement or agitation of the bale.

Preferably, the loose material returning means comprises a conveyor belt or the like.

Preferably, the loose material returning means is adapted to transfer loose material between the loose material receiving means and the baling means.

According to a fourth aspect of the present invention there is provided a bale threshing device comprising bale shredding means adapted to shred a bale into loose crops, threshing means adapted to thresh the loose crops and separate the resultant straw from the resultant seeds.

The resultant seeds may comprise the desirable grain and also weed seeds, chaff and light or broken grain.

According to a fifth aspect of the present invention there is provided a system for the manufacture of paper or strawboard, the system comprising:
i) a bale threshing device comprising bale shredding means adapted to shred a bale into loose crops, threshing means adapted to thresh the loose crops and separate resultant straw from resultant seeds;
ii) delivery means adapted to deliver the resultant straw to resultant straw processing means; and
iii) resultant straw processing means adapted to process the resultant straw into paper or strawboard.

According to a sixth aspect of the present invention there is provided a system for the generation of electricity, the system comprising:
i) a bale threshing device comprising bale shredding means adapted to shred a bale into loose crops, threshing means adapted to thresh the loose crops and separate resultant straw from resultant seeds;
ii) a furnace adapted to receive and combust the resultant straw;
iii) electricity generating means operable to convert the heat released by the combustion of the straw into electricity.

Preferably, the system of the fifth or sixth aspect further comprises baling twine removal means.

Preferably, the system of the fifth or sixth aspect further comprises separating means operable to separate the resultant seeds into
i) desirable grain; and
ii) undesirable grain.

The separating means may comprise at least one sieve which at least one sieve may be adapted to rotate or shake when in use. The separating means may further comprise a fan adapted to blow air through the resultant seeds.

Preferably, the system of the fifth or sixth aspect further comprises desirable grain delivery means operable to deliver the desirable grain to a drying area. The drying area may be a conventional dryer.

Preferably, the electricity generating means comprises water which is boiled to produce steam. Preferably, the steam is forced under pressure to drive a turbine and thereby generate electricity. Preferably, after the steam has passed through the turbine, the residual heat in the steam/condensed water may be used as a source of heat to facilitate drying of the desirable grain.

Preferably, the system of the fifth or sixth aspect further comprises undesirable grain delivery means operable to deliver the undesirable grain to a storage area. Advantageously, the undesirable grain which may comprise weed seeds, chaff and light or broken grain may be used to produce animal feed by a known process.

For a better understanding of the invention, and to show how embodiments of the same may be carried into effect, reference will now be made, by way of example, to the accompanying diagrammatic drawings in which:

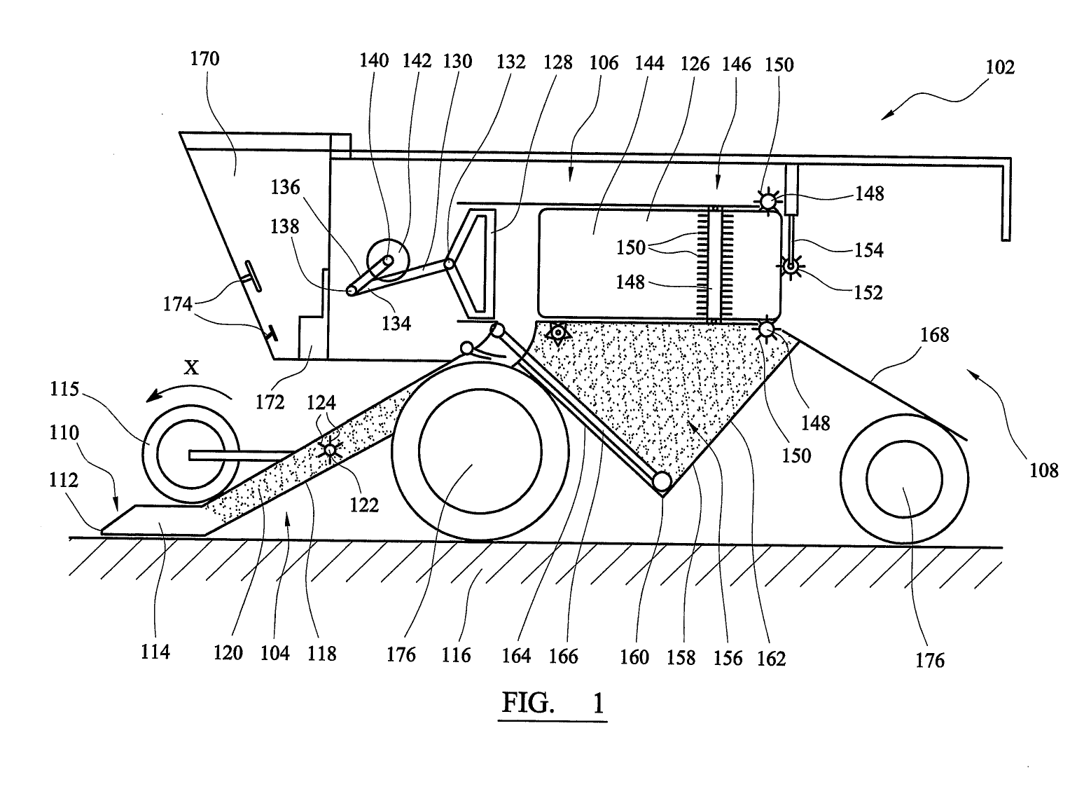

FIG. 1 shows a sectional side view through a harvesting device;

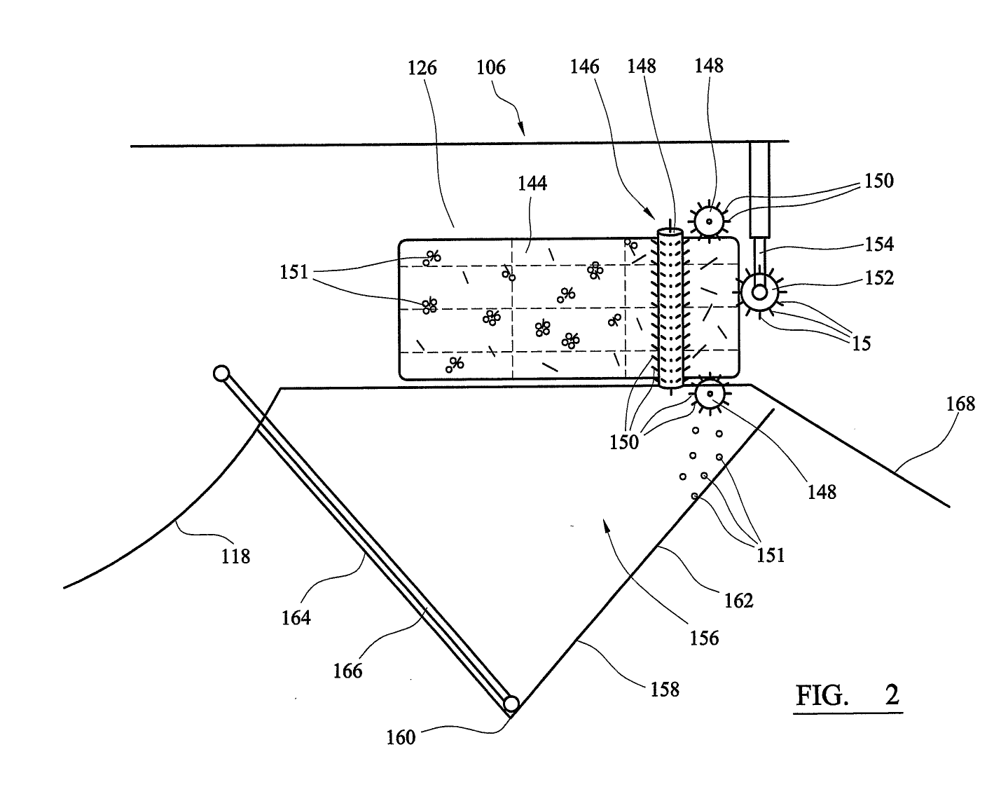

FIG. 2 shows a sectional side view through a portion of the harvesting device;

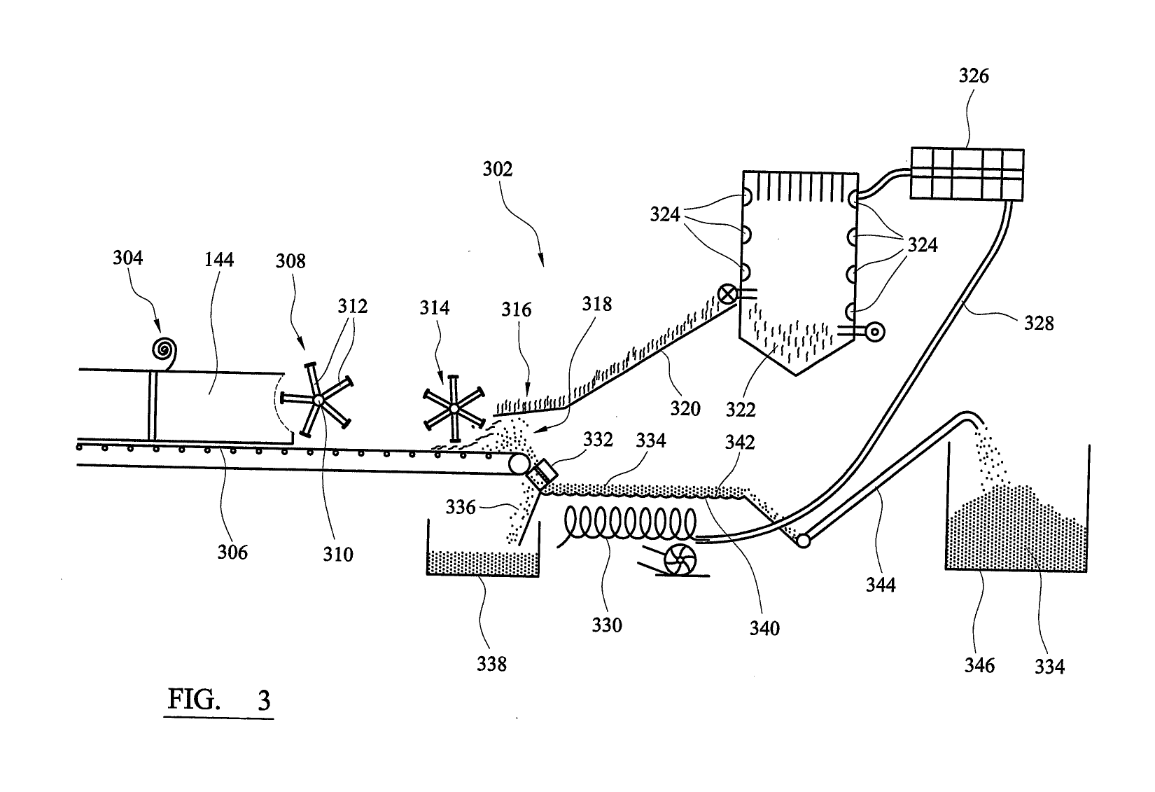

FIG. 3 shows a schematic side view of a system for generating electricity; and

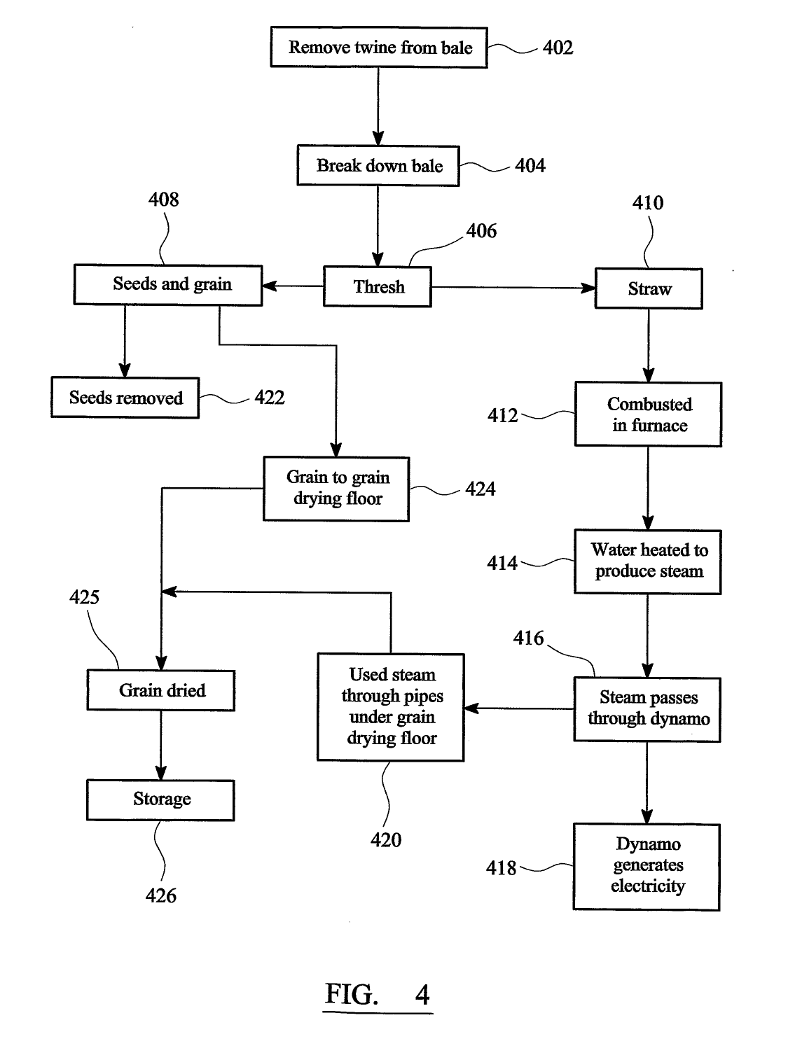

FIG. 4 shows a schematic flow diagram of steps in a system for generating electricity.

Referring to FIG. 1 there is shown a cross-sectional side view through a harvesting and baling machine 102 having a harvesting region 104 situated toward a front end thereof, a baling region 106 situated generally toward a central portion thereof and a delivery region 108 situated toward a rear end thereof.

The harvesting region 104 comprises a cutting portion 110 in the form of a sharpened leading edge 112 of a shelf 114 which extends across the width of the front of the machine 102 and is situated close to the ground 116 along which the machine 102 travels to ensure that the crop is cut close to the ground 116. The sharpened leading edge 112 of the shelf 114 may comprise a number of triangular shaped blades (not shown) which are adapted to pass over each other in use and thereby chop the crop. Situated above the shelf 114 is a cylindrical member 115 having a number of fingers (not shown) protruding therefrom. In use, the cylindrical member 115 rotates about its longitudinal axis in a direction indicated by the arrow “X” causing the fingers attached thereto to gather the crop and direct it toward the machine 102. Extending from the shelf 114 toward the baling region 106 at an incline angle of about 40° to the horizontal is a conveyor 118 along which the harvested crop 120 travels. Mounted vertically above the conveyor is a cylindrical roller 122 having radially extending blades 124 attached thereto.

When in use, the roller 122 is rotated above the conveyor by a motor (not shown) thereby using the radially extending blades 124 to chop the crop 120 into smaller pieces.

At an upper end of the conveyor 118, distal to the shelf 114 is the baling region 106 which comprises a baling chamber 126 which is a cuboidal void. At an end of the chamber 126 proximal to the front of the machine 102 is a rectangular pressure plate 128 having substantially the same surface area as a cross-section through the chamber 126. A front side of the plate 128 is pivotally connected to a first end 132 of a shaft 130. A second end 134 of the shaft 130 is pivotally connected to a first end 138 of a second shaft 136. A second end 140 of the second shaft 136 is rigidally connected to a wheel 142 such that it extends radially therefrom. The wheel 142 may be rotated, in use, to thereby rotate the second shaft 136 which causes lateral movement of the first shaft 130 and the plate 128. In this manner, the plate 128 is reciprocated by rotation of the wheel 142.

In use, the crop 120 travels up the conveyor 118 into the baling chamber 126. When the baling chamber 126 is full, the wheel 142 is rotated thus causing the plate 128 to move laterally into the chamber 126 and thereby reduce the interior volume of the chamber 126. In this manner, the crop 120 is compressed into a bale 144. The bale 144 is then bound with twine which is tied by a knotter mechanism (not shown) such as the type known in the art.

Referring now also to FIG. 2 which shows the baling portion 106 in more detail, situated toward a rear end of the baling chamber 126 is the bale stripping region 146. The bale stripping region 146 comprises four stationary bale strippers 148 which are orientated to align with four sides of the baling chamber 126 and thereby form a rectangular aperture around the bale 144. Each bale stripper 148 is cylindrical in shape, has fingers 150 extending radially therefrom and is able to rotate about its longitudinal axis. The longitudinal axis of each cylindrical bale stripper 148 is orientated to be parallel with a plane of a face of the bale 144. Located at a rear of the baling chamber 126 is a moveable bale stripper 152. The moveable bale stripper 152 is similar in shape and size to the stationery bale strippers 148 and has similar radially extending fingers 150. The moveable bale stripper 152 is orientated such that its longitudinal axis is parallel to the plane of a rear face of the bale 144. The moveable bale stripper is moveable vertically up and down the rear face of the bale (within the plane of the rear face of the bale) 144 by virtue of extendable and retractable arms 154.

Vertically beneath the baling chamber 126 is a loose material collection region 156 which comprises a trough 158 which is laterally coextensive with the baling chamber 126. The trough 158 is V shaped in section with a first side 162 extending from a bottom 160 of the trough 158 to the rear of the baling chamber 126 and a second side 164 extending from the bottom 160 of the trough 158 to the front of the baling chamber 126. Extending from substantially the bottom 160 of the trough 158 along the second side thereof 164 to the front of the baling chamber 126 is a conveyor 166.

In use, after the bale 144 is compressed and bound as described above, the moveable bale stripper 152 removes any loose surface grain (or other loose material) 151 from the rear face of the bale 144 by rotating parallel to the rear face of the bale causing the radially extending fingers 150 to brush loose grain from the rear face of the bale 144. The moveable bale stripper 152 moves up and down the rear face of the bale 144 thereby stripping loose material from substantially the entire rear surface of the bale 144. After the rear face of the bale 144 has been stripped, the bale is moved toward the rear of the machine 102 causing side faces and top and bottom faces thereof to move under the stationary bale strippers 148. In a similar manner as described with reference to the moveable bale stripper 152, the fingers 150 of the strippers 148 brush loose material 151 from the side faces and top and bottom faces of the bale 144. When the bale 144 has moved toward the rear of the machine the moveable bale stripper 152 moves over a front face of the bale 144 and thereby brushes loose material 151 from the surface thereof.

The loose material 151 that is stripped from the bale 144 falls under gravity into the trough 158 and, again under gravity, the loose material 151 gathers at the bottom 160 of the trough 158. The loose material 151 is then transported from the bottom 160 of the trough 158 by the conveyor 166 back to the front of the baling chamber where it is added to the next bale 144. In this manner, loose material is concentrated toward the centre of the bale because loose material 151 has been removed (stripped) from the surface regions of the bale 144 and added to the next bale.

After exiting the rear of the baling portion 106, the bale 144 enters the delivery portion 108 toward the rear of the machine 102. The delivery portion 108 comprises a ramp 168 sloping downwardly from the rear of the baling chamber 126 to the rear of the machine 102. The bale 144 upon leaving the baling chamber 126 slides down the ramp 168 and is deposited behind the machine 102.

The machine 102 further comprises a cabin 170 toward the front end thereof which comprises a seat 172 upon which a user may sit and usual vehicle driving controls 174 as are known in the art. Further, the machine 102 comprises wheels 176 and driving mechanism (not shown) to allow it to move over the ground 116.

Referring to FIG. 3 there is shown a schematic view of a bale processing plant 302 and FIG. 4 shows a schematic flow diagram of the plant 302. The plant 302 comprises a conveyor 306 along which a bale 144 travels. On the conveyor is a baling twine remover 304 as is known in the art which removes the baling twine from the exterior of the bale 144 (box 402, FIG. 4). The conveyor 306 then moves the bale 144 to a bale shredding roller 308 which has blades 312 extending radially away from a cylindrical shaft 310. In use, the roller 308 rotates about a longitudinal axis to thereby cause the blades 312 to shred the bale into smaller parts (box 404, FIG. 4). As the shredded bale reaches an end of the conveyor 306 it is threshed by a threshing device 314 such as the kind well known in the art (box 406, FIG. 4). The threshing device 314 threshes and separates the resultant mixture into straw 316 and grain, weed seeds and chaff 318 (box 408 and 410, FIG. 4).

The straw 316 travels along a conveyor 320 which extends from the threshing device 314 to a furnace 322. The furnace comprises a number of pipes 324 in its interior volume which pipes 324 contain water. The interior and exterior of the pipes 324 are not in fluid communication, but walls of the pipes 324 may conduct heat between the exterior and interior of the pipes 324. The straw 316 is combusted within the furnace 322 (box 412, FIG. 4) which releases heat to thereby heat the water within the pipes 324 to generate steam (box 414, FIG. 4). The interior of the pipes 324 are in fluid communication with a turbine 326 of the kind known in the art. The heat released by the combustion of the straw 316 causes pressured steam to drive the dynamo 326 (box 416, FIG. 4) and thereby generate electricity (box 418, FIG. 4). As the steam cools and condenses it is fed from the dynamo down a pipe 328 to a coiled pipe 330 which is situated beneath a grain drying floor 340 (box 420, FIG. 4).

The grain, weed seeds and chaff 318 separated by the threshing device 314 are moved to a separating device 332 which separates the grain 334 from the weed seeds and chaff 336 the latter being fed into a storage bin 338 where it may be used later for animal feed (box 422, FIG. 4). The grain 334 is fed on to the grain drying floor (box 424, FIG. 4) along which it is slowly transported by a conveyor 342 toward a further conveyor 344 which deposits the grain 334 into a storage bin 344 (box 426, FIG. 4).

Situated beneath the coiled pipe 330 is a fan 348 which blows air upward over the coiled pipe 330 and through the grain drying floor 340. In this manner drying of the grain 334 is facilitated (box 425, FIG. 4).

A harvester made in accordance with the present invention advantageously harvests the crop and bales it without the need to thresh it in the field. Furthermore, the provision of loose material strippers allows a surface region of the bale to be stripped of loose material and this loose material can then be added to the next bale. In this manner, the likelihood of losing grain is minimised by concentrating any loose material toward the centre of a bale. Also, any weed seeds are prevented from returning to the field and weed infestation is thereby prevented.

A threshing system in accordance with the present invention advantageously uses waste straw to generate electricity by combustion. Also, residual heat in heated water used in the generation of electricity is utilised to dry grain. The electricity generated could be used to as a source of power for a small community. Additionally residual heat in the water could be used to heat a small community.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A harvesting device for harvesting agricultural crops comprising:
harvesting means adapted to harvest an agricultural crop;
baling means adapted to compress the agricultural crop into bales; and
bale stripping means adapted to strip loose material from at least a portion of the surface region of a bale of agricultural crop.

2. A harvesting device according to claim 1, wherein the harvesting means comprises at least one cutting portion operable to cut the agricultural crop.

3. A harvesting device according to claim 2, wherein the at least one cutting portion comprises a blade which extends across the width of the harvesting device.

4. A harvesting device according to claim 1, wherein the harvesting means comprises a plurality of cutting portions operable to cut the agricultural crop.

5. A harvesting device according to claim 1, wherein the harvesting means comprises a gathering member adapted to rotate in a direction such that it pulls the arable crop and feeds it into the harvesting device.

6. A harvesting device according to claim 1, wherein the baling means comprises a baling chamber.

7. A harvesting device according to claim 1 any preceding claim, wherein the harvesting device comprises crop delivery means adapted to deliver the harvested crop to the baling chamber.

8. A harvesting device according to claim 7, wherein the harvesting device comprises chopping means adapted to chop the harvested crop into smaller parts while the harvested crop is situated on the crop delivery means.

9. A harvesting device according to claim 1, which further comprises loose material receiving means, which loose material receiving means are adapted to receive loose material which is stripped from at least a portion of a surface region of a bale of agricultural crop.

10. A harvesting device according to claim 6, wherein the bale stripping means are adapted to strip loose material from at least a portion of the surface region of the bale of arable crop while said bale of crop is located in the baling chamber.

11. A harvesting device according to claim 1, wherein the harvesting device comprises loose material returning means adapted to return loose material which has been stripped from at least a portion of the surface region of the bale of agricultural crop to the baling means.

12. A harvesting device according to claim 11 when dependent on any of claims 6 to 10, wherein the loose material returning means is adapted to transfer loose material between the loose material receiving means and the baling means.

13. A baling machine adapted to gather and compress an agricultural crop into discrete packages, the baling machine comprising a bale stripping device comprising bale stripping means adapted to strip loose material from at least a portion of a surface region of a bale of agricultural crop.

14. A bale stripping device comprising bale stripping means adapted to strip loose material from at least a portion of a surface region of a bale of agricultural crop.

15. A device or machine according to claim 1, wherein the bale stripping means comprises at least one bale stripping member.

16. A device or machine according to claim 15, wherein the at least one bale stripping member comprises brushing means.

17. A device or machine according to claim 16, wherein the brushing means are preferably adapted to brush at least a portion of the surface region of a bale of agricultural crop

18. A device or machine according to claim 1, wherein the bale stripping means comprises a plurality of bale stripping members.

19. A device or machine according to claim 15, wherein the bale stripping means comprises bale stripping members situated to correspond with each face of a bale to be stripped.

20. A device or machine according to claim 15, wherein at least one of the at least one bale stripping member is substantially cylindrical.

21. A device or machine according to claim 15, wherein at least one of the or each bale stripping member is adapted to rotate.

22. A device or machine according to claim 15, wherein at least one of the or each bale stripping members is substantially cylindrical and adapted to rotate about its longitudinal axis.

23. A bale threshing device comprising bale shredding means adapted to shred a bale into loose crops, threshing means adapted to thresh the loose crops and separate the resultant straw from the resultant seeds.

24. A system for the manufacture of paper or strawboard, the system comprising:
(i) a bale threshing device comprising bale Shredding means adapted to shred a bale into loose crops, threshing means adapted to thresh the loose crops and separate resultant seeds,
(ii) delivery means adapted to deliver the resultant straw to resultant processing means; and
(iii) resultant straw processing means adapted to process the resultant straw into paper or strawboard.

25. A system for the generation of electricity, the system comprising:
(i) a bale threshing device comprising bale shredding means adapted to shred a bale into loose crops, threshing means adapted to thresh the loose crops and separate resultant straw from resultant seeds;
(ii) a furnace adapted to receive and combust the resultant straw;
(iii) electricity generating means operable to convert the heat released by the combustion of the straw into electricity.

26. The system of claim 24 which further comprises baling twine removal means.

27. The system of claim 24 which further comprises separating means operable to separate the resultant seeds into
i) desirable grain; and
ii) undesirable grain.

28. The system of claim 27, wherein the separating means comprises at least one sieve.

29. The system of claim 28, wherein the separating means further comprises a fan adapted to blow air through the resultant seeds.

30. The system of claim 24 which further comprises desirable grain delivery means operable to deliver the desirable grain to a drying area.

31. The system of claim 25, wherein the electricity generating means comprises water which is boiled to produce steam.

32. The system of claim 24 which further comprises undesirable grain delivery means operable to deliver the undesirable grain to a storage area.
